(19) United States
(12) Patent Application Publication
(10) Pub. No.: US 2007/0297125 A1
(43) Pub. Date: Dec. 27, 2007

(54) Slim profile foldable device

(75) Inventor: Esa-Sakari Maatta, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/476,917

(22) Filed: Jun. 27, 2006

(51) Int. Cl. G06F 1/16

(52) U.S. Cl. 361/681

(57) ABSTRACT

A slim profile foldable device has a body and a cover configured for articulated movement about a pivot axis between a closed position and an open position. A frame member is configured for co-operative connection with the body and with the cover and bendable about a folding axis and is non-accessible in the device's closed position and is accessible in the device's open position. The frame member may comprise two sections joined by a compliant hinge configured to bend about the folding axis when the device moves between the open and closed positions and comprises a substantially smooth outward facing surface in the device open position.

### TECHNICAL FIELD

The present invention relates generally to foldable devices and more specifically with a slim profile foldable device.

### BACKGROUND OF THE INVENTION

There is a strong demand to create thinner and thinner devices, particularly mobile telephone devices. One way to realize a thin device is to make the folding (display) cover as thin as possible, however there is a limiting factor in robustness of a thin display cover structure in conventional devices because the thin display cover becomes very fragile in everyday use.

### SUMMARY OF THE INVENTION

In accordance with a broad aspect of the invention, a novel concept of a thin or slim foldable device is presented. A body and a cover are configured for articulated movement about a pivot axis between a closed position and an open position. A frame member is configured for co-operative connection with the body and with the cover. The frame member is bendable about a folding axis and is non-accessible in the device's closed position and is accessible in the device's open position. The frame member may comprise two sections joined by a compliant hinge configured to bend about the folding axis when the device moves between the open and closed positions and comprises a substantially smooth outward facing surface in the device open position.

In one aspect, one section of the frame member may be fixedly connected to the body, and the other section configured for sliding engagement with the cover so that the body connects to the cover by the frame member.

In another aspect, a main hinge connects the body and the cover.

In a further aspect, the end portion of the cover is configured for receiving an end portion of the frame member and a frame hinge element may be provided for receiving the end portion of the frame member and arranged for rotation about a frame hinge pivot axis. In this instance, the main hinge pivot axis, the folding axis and the frame hinge pivot axis are spaced from and substantially parallel with one another.

In a further aspect, the frame member comprises a display and a keypad joined by a compliant hinge to bend about the folding axis. The body is arranged to fixedly carry the keypad and the cover is arranged to slidingly carry the display wherein the display is configured for longitudinal movement in the cover to accommodate body-to-cover end-to-end length changes when the device moves between its open and closed positions. The display may be a flexible display to follow contours of the cover as the device moves between its open and closed positions.

The device may be configured for example, for operation as a mobile terminal.

### BRIEF DESCRIPTION OF THE DRAWINGS

Additional features and benefits of the slim foldable device will become readily apparent from the following description taken in conjunction with the drawings wherein:

FIG. 1 is a schematic perspective view of a slim profile foldable device embodying the present invention shown in the device open position;

FIG. 2 is a schematic side view of the slim profile foldable device of the present invention shown in the device's closed position;

FIG. 3 is a schematic side view of the slim profile foldable device of the present invention shown in a position between the device open and closed positions;

FIG. 4 is a schematic side view of the slim profile foldable device of the present invention in the device open position;

FIG. 5 is a schematic somewhat perspective cut-away view of the slim profile foldable device of the present invention in the device closed position;

FIG. 6 is a schematic somewhat perspective cut-away view of the slim profile foldable device of the present invention shown in a position between the device open and closed positions;

FIG. 7 is a schematic somewhat perspective cut-away view of the slim profile foldable device of the present invention shown in the device open position;

FIGS. 8A-8C are schematic fragmentary view representations of the main hinge showing the flexi-cable path around and not through the main hinge connection between the body and the cover for the device closed, intermediate and open positions;

FIG. 9 is an exploded schematic view of an embodiment of the slim profile foldable device of the present invention;

FIG. 10A is a schematic side view representation of the solution provided by the slim profile foldable device of the present invention compared to other foldable device solutions shown in FIGS. 10B-10C;

FIG. 11A is a schematic side view representation of the solution provided by the slim profile foldable device of the present invention compared to the foldable device solution shown in FIG. 11B;

FIG. 12 is a schematic side view of another embodiment the slim profile foldable device of the present invention in the device open position showing a curved body and cover;

FIG. 13 is a schematic side view of an alternate embodiment of the slim profile foldable device of the invention shown in the device closed position;

FIG. 14 is a schematic side view of the slim profile foldable device of FIG. 13 shown in a position between the device open and closed positions;

FIG. 15 is a schematic side view of the slim profile foldable device of FIG. 13 shown in the device open position;

FIG. 16 is a schematic fragmentary perspective view of the slim profile foldable device of FIG. 13 showing the end portion of the frame member and the end portion of the cover configured for co-operative connection with one another.

### WRITTEN DESCRIPTION OF PREFERRED EMBODIMENTS

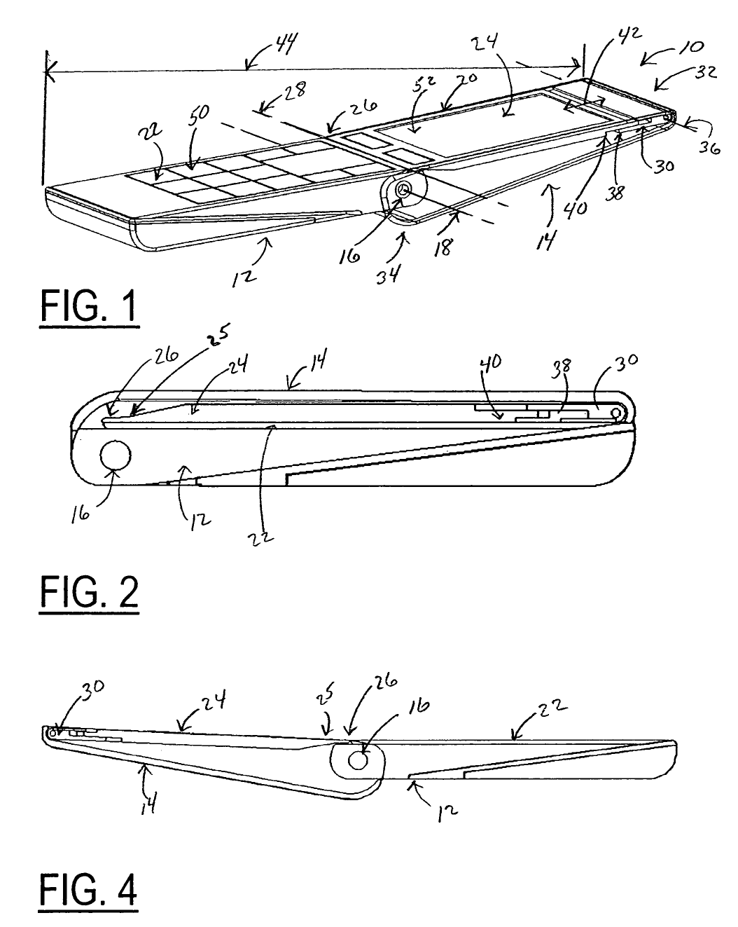

Turning now to the drawings, a schematic perspective view of a slim profile foldable device embodying one example of the present invention is illustrated in FIG. 1 and generally designated 10. The foldable device 10 is shown in the device open position and includes a body generally designated 12 and a cover generally designated 14. The body 12 and cover 14 are connected by a main hinge generally designated 16 and are arranged for articulated movement with respect to one another about the main hinge pivot axis 18 passing axially lengthwise through the hinge 16. The main hinge 16 may be of any suitable construction and design to provide the articulated movement of the body 12 and cover 14 such as auto-open, bi-stable and friction or “free stop”.

The body 12 and cover 14 carry a frame member generally designated 20, which is arranged in two sections 22 and 24, respectively. The two sections 22, 24 of the frame member 20 are joined by a compliant hinge generally designated 26 and bendable for movement about a folding axis 28 passing axially lengthwise through the compliant hinge 26 when the foldable device 10 moves between its open and closed positions. Alternately, the two sections 22, 24 of the frame member 20 may be two separate parts joined by a suitable hinge element bendable about the folding axis 28.

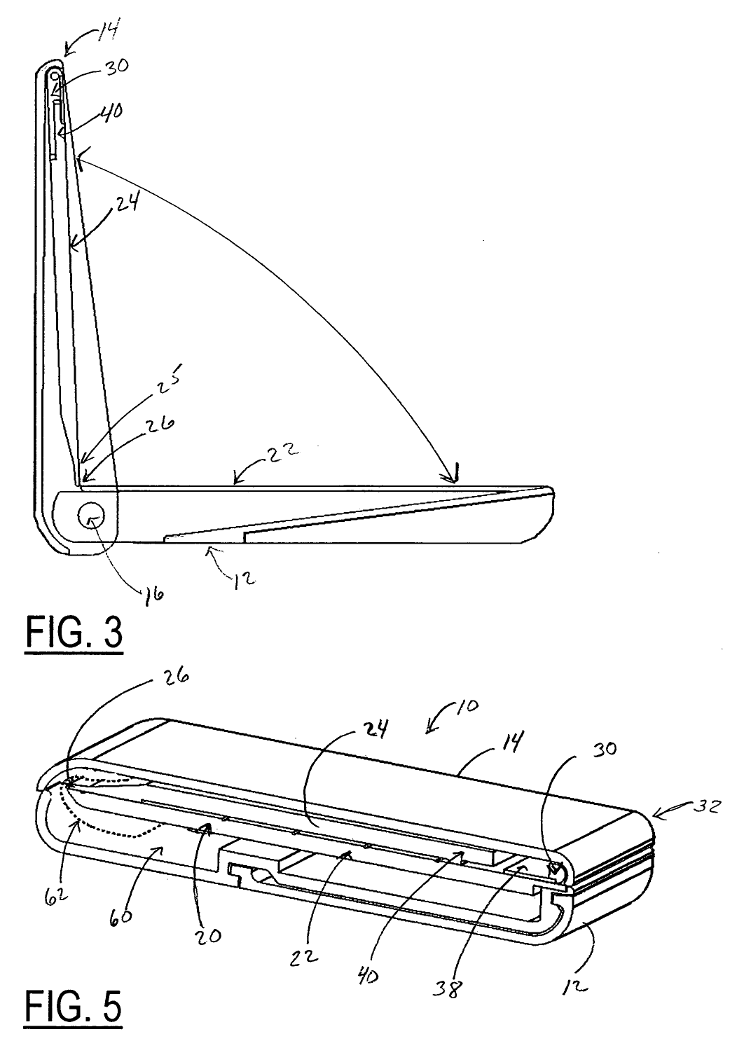

A frame hinge element generally designated 30 is located at one end 32 opposite the main hinge end 34 of the cover 14 and is arranged for rotation about a pivot axis 36 passing axially lengthwise through the hinge element 30. The frame hinge element 30 is configured at one end 38 to receive a complementary shaped and dimensioned end portion 40 of the frame member 20. The end portion 40 of the frame member 20 moves with a reciprocating motion in a linear direction shown by the arrow 42 in the end 38 of the hinge element 30 defining a telescopic-like linear movement to accommodate the changes in end-to-end length dimension 44 of the body 12 and cover 14 as the device moves between its open and closed positions as shown in FIGS. 2-4. It will be recognized by those skilled in the art that the end portion 25 of the frame member 20 opposite the end portion 40 and the hinge element 26 may be configured to provide the telescopic-like linear movement to compensate for end-to-end length variations of the body and cover moving between the open and closed positions.

Alternately, the end portion of the frame member 20 may be fixedly received in the end 38 of the frame hinge element 30 and the frame hinge element 30 arranged to move with reciprocating motion in a linear direction with respect to the end 32 of the cover 14. In either embodiment, the combination of the end portion 40 of the frame member 20 and the frame hinge element 30 moves with a composite rotation and linear motion as the device moves between its open and closed positions to compensate for end-to-end length variations of the body and cover moving between the open and closed positions.

The frame member 20 may be constructed in the section 22 with a keypad generally designated 50. The keypad 50 may have an array of keys suitably arranged to carryout the intended function of the foldable device 10, for example a communication keypad when the foldable device is configured as a mobile terminal.

A display generally designated 52 may be constructed in the section 24 of the frame member 20 to present information, graphics, text in accordance with the intended function of the foldable device 10, which for example may be configured as a mobile terminal including a suitable processor, memory, transceiver and antenna as necessary to carry out the functions of the mobile terminal.

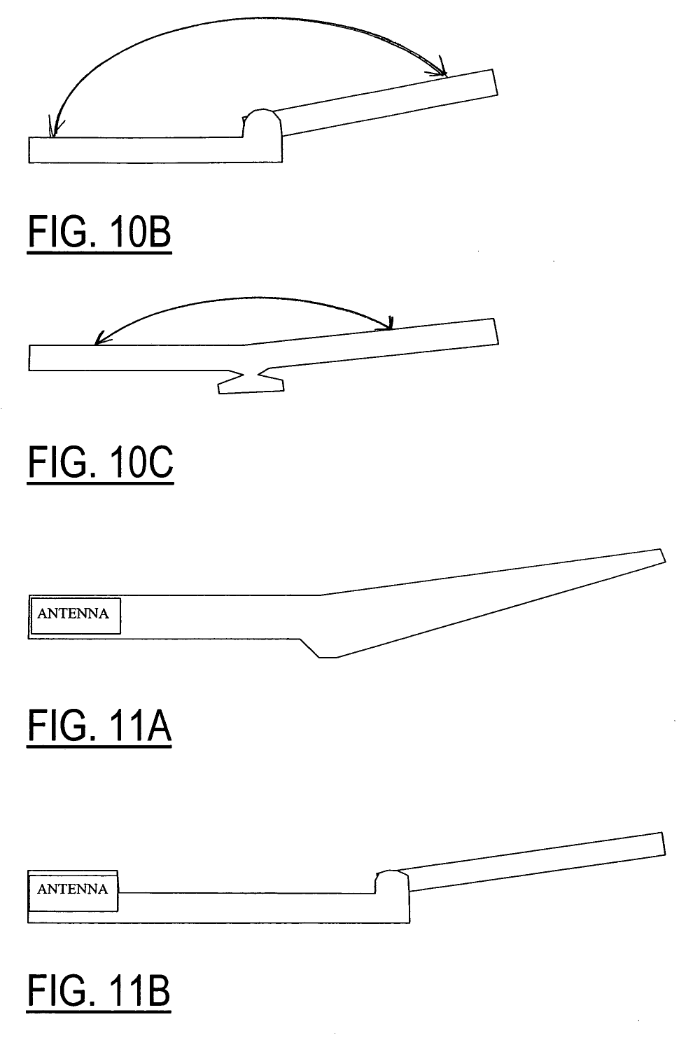

In the foregoing example of the slim foldable device 10, the main hinge pivot axis 18, folding axis 28 and frame hinge element pivot axis 36 are spaced apart and substantially parallel to one another and the co-operative interaction of the combination of the three hinges, the main hinge 16, compliant hinge 26 and frame hinge element 30 working together enables a unique form factor such that the foldable device inner and outer surfaces are substantially smooth as illustrated schematically in FIGS. 10A and 11A, that is, the form factor has no steep steps between the body and the cover compared to the form factors illustrated schematically in FIGS. 10B, 10C and 11B. Thus, the shape of the foldable device surfaces remains “smoother” when the device is opened and closed.

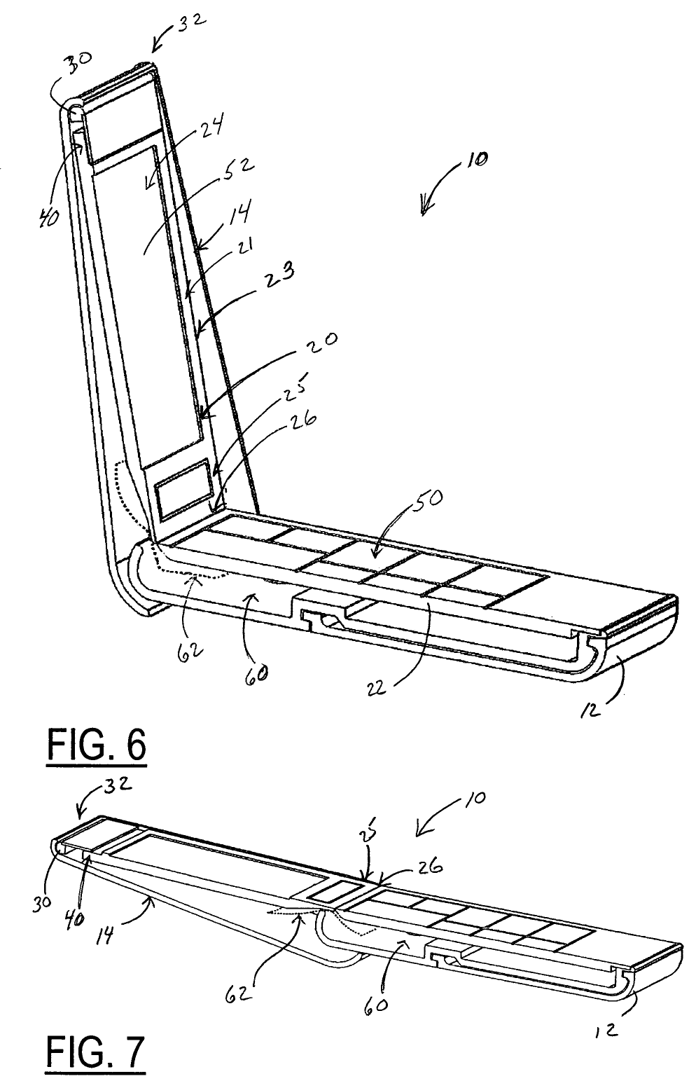

The three-axis hinge construction of the slim profile foldable device of the present invention enables a thin but robust folding display cover in which the advantages of a mono-block architecture are retained because it is not necessary to divide the electronics into 2 equally thin device sections. As illustrated schematically in the cutaway views shown in FIGS. 5-7, the body 12 is thick compared to the thin display cover 14 and includes a relatively large cavity generally designated 60 to house suitable electronic circuitry, control circuitry, processor and signaling circuitry, display and graphic control circuitry, and other circuitry including appropriate battery and power supply circuitry as necessary to carry out the intended functions of the device, for example a mobile telephone.

With reference to FIGS. 11A and 11B, it is seen that the thickness of the body of the slim profile foldable device embodying the invention accommodates the antenna component in the case of a mobile terminal without projecting or protruding beyond the surface as is the case in the foldable device shown schematically in FIG. 11B. Since substantially all of the circuitry and power components in the slim profile foldable device of the invention are located in the body 12, the display cover 14 carrying the display 52 can be made very thin and still protect the display. The display cover 14 may be made of any suitable material such as metal, steel, titanium, composite material to provide strength and thinness. Likewise, the body 12 may be made of any suitable material well known to those skilled in the art.

In a further example of an embodiment of the slim profile foldable device of the present invention, and with reference to FIGS. 5-7, the first section of the frame member 20 carrying the keypad 50 is fixedly connected to the body 12 and the other section of the frame member 20 carrying the display 52 has a marginal side edge portion 21 configured for complementary sliding engagement in a grove or slot 23 in the side wall of the cover 14. In this example, the body 12 is connected for articulated movement with the cover 14 by the two sections of the frame member 20.

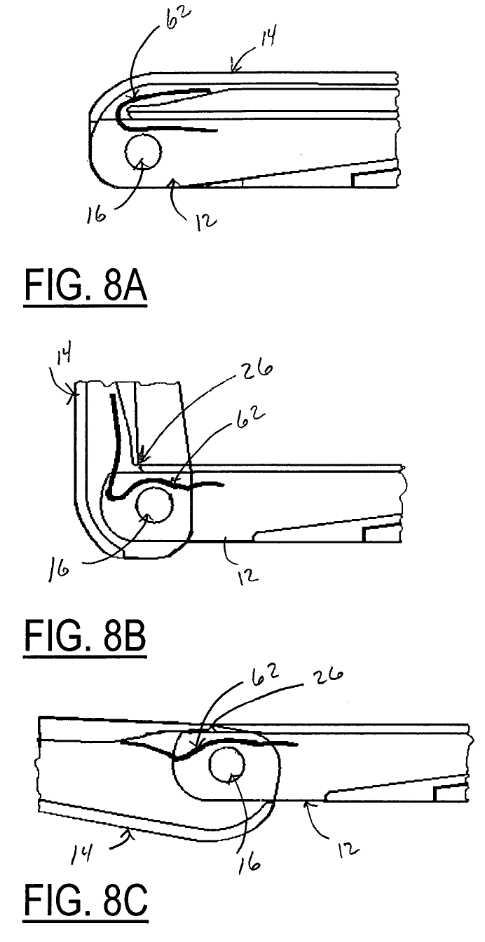

The absence of conventional hinge elements between the main body 12 and the cover 14 and the frame member 20 avoids the necessity of passing wiring and signaling cables through complex hinge arrangements to electrically connect the foldable body and cover. In the slim profile foldable device 10, data and power transfer between the circuitry carried in the body 12 and the display 52 carried in the cover 14 is accomplished by suitable means such as a flexi-cable generally designated 62, which is routed from the main body 12 in the area between the main hinge 16 and the compliant hinge 26 to the display 52 carried by the display cover 14. Thus, wiring of the foldable device between the body and cover is simplified as shown in the fragmentary schematic illustrations shown in FIGS. 8A-8C of the main hinge 16 connecting the body 12 and cover 14.

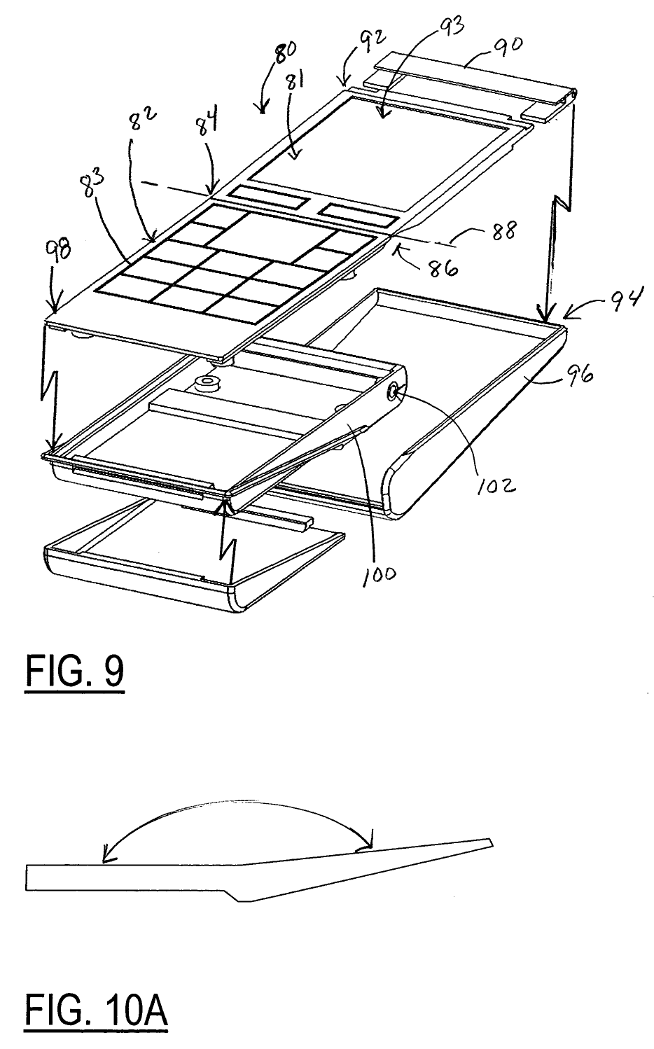

FIG. 9 shows an exploded schematic view of an embodiment of the slim profile foldable device generally designated 80 in which the frame member 82 may be manufactured or produced as a unitary component using suitable construction methods and materials with a display 81 in one section 93 and a keypad 83 in a section 98 on the other side of a compliant hinge 84. A weakened area 86 may form the compliant hinge 84 so that the frame member 82 is bendable about the folding axis 88 when the foldable device is moved between its open and closed positions. The frame hinge element 90 is configured to receive the end portion 92 of the frame member 82. The frame member 82 is rotatably connected to the end portion 94 of the display cover 96. The section 98 of the frame member 82 is fixedly connected to the body 100. The body 100 is connected to the display cover 96 by a main hinge 102 for articulated movement between the body 100 and the cover 96 and to the display by the compliant hinge 84.

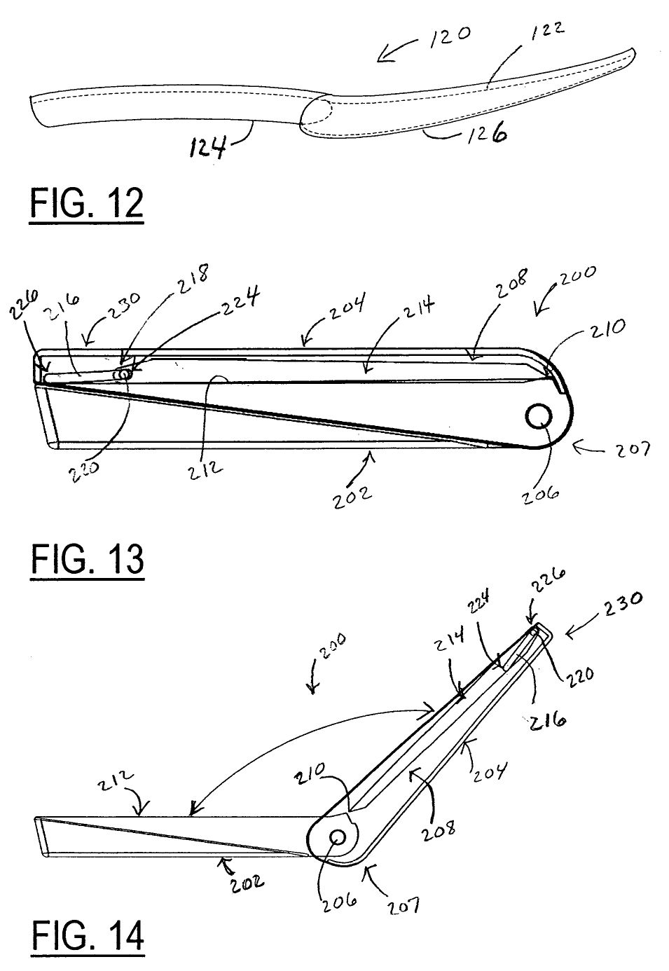

Referring to FIG. 12, a schematic side view of another example of an embodiment the slim profile foldable device of the present invention is shown therein and generally designated 120 in the device open position showing a curved body 124 and a curved display cover 126. In this embodiment, the display 122 is flexible and follows the curvature of the cover and body. The body 124, cover 126 and display 122 may be co-operatively connected as described above in connection with FIGS. 1-9.

Turning now to FIGS. 13-16 an alternate embodiment of a slim profile foldable device embodying another example of the present invention is illustrated therein and generally designated 200. The foldable device 200 includes a body generally designated 202 and a cover generally designated 204. The body 202 and cover 204 are connected by a main hinge generally designated 206 and are arranged for articulated movement with respect to one another about the main hinge pivot axis passing axially lengthwise through the hinge 206. The main hinge 206 may be of any suitable construction and design to provide the articulated movement of the body 202 and cover 204 such as auto-open, bi-stable and friction or “free stop”.

The body 202 and cover 204 carry a frame member generally designated 208, which is arranged in two sections 212 and 214, respectively. The two sections 212, 214 of the frame member 208 are joined by a compliant hinge generally designated 210 and bendable for movement about a folding axis passing axially lengthwise through the compliant hinge 210 when the foldable device 200 moves between its open and closed positions.

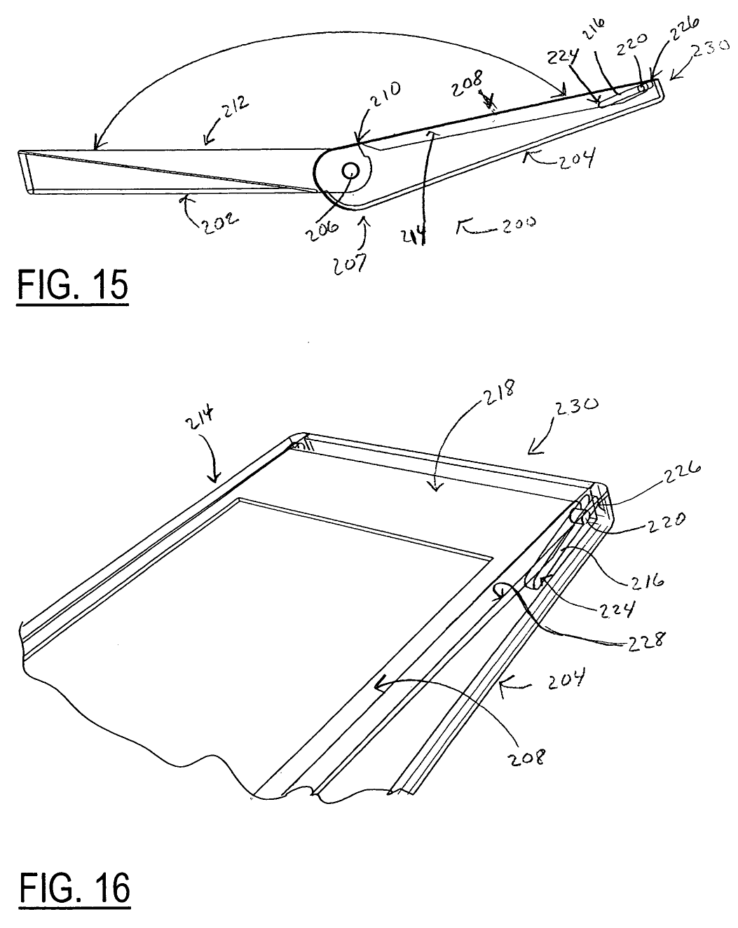

One end 230 of the cover 204 opposite the main hinge end 207 includes an inclined groove or slot 216 in its interior side wall 228 and is configured to receive a complementary shaped and dimensioned lateral end projection 220 of the end portion 218 of the frame member 208. The end portion 218 of the frame member 208 moves with a reciprocating motion as guided by the projection 220 in the slot 216 to accommodate changes in end-to-end length dimension of the body 202 and cover 204 as the device 200 moves between its open and closed positions as shown in FIGS. 13-14. In the device closed position as shown in FIG. 13, the projection 220 and accordingly the end portion 218 of the frame member 208 is at one end 224 of the slot 216 nearest the main hinge end 207, and at some position of the cover 204 relative to the body 202 during its travel between the device open and closed positions, the projection 220 is at an opposite end 226 of the slot 216 furthest from the main hinge end 207 as shown in FIG. 14. In the device 200 open position as shown in FIG. 15, the projection 220 is located as a position intermediate its furthermost movement and position between the ends 224 and 226 of the slot 216. Thus it can be seen that end-to-end length variations of the body and cover are compensated for when moving between the open and closed positions.

The invention claimed is:

1. Device, comprising:
a body;
a cover;
said body and said cover configured for articulated movement about a pivot axis between a closed position and an open position, and
a frame member configured for co-operative connection with said body and with said cover, bendable for movement about a folding axis and non-accessible in said device closed position and accessible in said device open position.

2. The device as defined in claim 1 wherein said frame member comprises two sections joined by a suitable hinge element configured to bend about said folding axis when said device moves between said open and said closed positions.

3. The device as defined in claim 1 wherein said frame member comprises two sections joined by a compliant hinge configured to bend about said folding axis when said device moves between said open and said closed positions.

4. The device as defined in claim 2 further comprising one of said two sections of said frame member connected to said body and the other of said two sections of said frame member connected to said cover.

5. The device as defined in claim 1 further comprising a main hinge for connecting said body and said cover for articulated movement.

6. The device as defined in claim 2 further comprising said one section of said frame member fixedly connected to said body and said other of said two sections of said frame member is configured for sliding engagement with said cover.

7. The device as defined in claim 1 further comprising said cover having an end portion configured for receiving an end portion of said frame member.

8. The device as defined in claim 7 further comprising a frame hinge element configured for receiving said frame member end portion.

9. The device as defined in claim 8 further comprising said frame hinge element arranged for rotation about a frame hinge pivot axis.

10. The device as defined in claim 2 wherein said frame member further comprises a keypad carried in one section of said two sections.

11. The device as defined in claim 2 wherein said frame member further comprises a display carried in the other section of said two sections.

12. The device as defined in claim 1 wherein said frame member further comprises a substantially smooth outward facing surface in said device open position.

13. The device as defined in claim 12 wherein said frame member comprises a display and a keypad joined by a compliant hinge configured to bend about said folding axis, with said body arranged to fixedly carry said keypad and said cover arranged to slidingly carry said display wherein said display is configured for movement in said cover to accommodate body-to-cover end-to-end length changes in positions of said device between said device open and closed positions.

14. The device as defined in claim 13 further comprising an end portion of said frame member configured for limited rectilinear motion with respect to said cover when said device moves between said open and said closed positions.

15. The device as defined in claim 13 wherein said display further comprises a flexible display.

16. The device as defined in claim 13 further configured for operation as a mobile terminal.

17. Apparatus, comprising:
articulated means rotatable between an open and closed position for carrying a frame member means bendable about a folding axis and non-accessible in said closed position and accessible in said open position, and
frame member means configured for co-operative connection with said articulated means for imparting a substantially flat, smooth surface to said frame member means in said apparatus open position.

18. A method, comprising:
a frame member bendable about a folding axis responding to articulated movement of a body and a cover between an open and closed position, and
a frame member co-operatively connecting to the body and cover compensating for end-to-end length variations of the body and cover moving between the open and closed positions imparting a substantially flat, smooth surface to the frame member in the open position.
